(19) United States
(12) Patent Application Publication
(10) Pub. No.: US 2023/0392866 A1
(43) Pub. Date: Dec. 7, 2023

(54) FREEZE DRY SHELVING LAYUP

(71) Applicant: TechSource Systems LLC, Morgan, UT (US)

(72) Inventors: Matthew Pettit, Mountain Green, UT (US); Allen Pettit, Hurricane, UT (US); Logan Pettit, Layton, UT (US)

(21) Appl. No.: 18/317,808

(22) Filed: May 15, 2023

Related U.S. Application Data
(60) Provisional application No. 63/341,581, filed on May 13, 2022.

(51) Int. Cl. F26B 5/06

(52) U.S. Cl. CPC F26B 5/06

(57) ABSTRACT

Embodiments of an apparatus are provided. The apparatus may include a freeze dry shelf, a treatment, and a surface layer. The freeze dry shelf may include a body having a planar geometry. The treatment may be applied to at least a first portion of the body. The surface layer may be applied to at least a second portion of the body.

### CROSS-REFERENCE TO RELATED APPLICATIONS

The present application claims priority to U.S. Provisional Patent Application No. 63/341,581 entitled “FREEZE DRY SHELVING LAYUP”, filed on 13 May 2022. The entire contents of the above-listed application are hereby incorporated by reference for all purposes.

### BACKGROUND

Dehydration, the removal of moisture, is an effective form of processing and preservation. Freeze drying is a process that relies on sublimation to remove moisture from a material. Freeze drying is a process that relies on sublimation to remove moisture from a material. Freeze drying involves freezing the product and removing solid moisture through sublimation.

### BRIEF DESCRIPTION OF THE DRAWINGS

The present description will be understood more fully when viewed in conjunction with the accompanying drawings of various examples of a freeze dry shelving layup. The description is not meant to limit the freeze dry shelving layup to the specific examples. Rather, the specific examples depicted and described are provided for explanation and understanding of the freeze dry shelving layup. Throughout the description the drawings may be referred to as drawings, figures, and/or FIGs.

FIG. 1 illustrates a perspective view of a first side of a freeze dry shelf, according to an embodiment.

FIG. 2 illustrates a perspective view of a second side of a freeze dry shelf, according to an embodiment.

FIG. 3 illustrates a perspective view of a rack of freeze dry shelves, according to an embodiment.

### DETAILED DESCRIPTION

Freeze drying shelves with integrated sensing, as disclosed herein, will become better understood through a review of the following detailed description in conjunction with the figures. The detailed description and figures provide merely examples of the various embodiments of freeze dry shelves with integrated sensing. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Some conventional freeze dry shelves use mica sandwich sheets which implement a rolled edge joining and securing the layers of the sandwich. The rolled edge has an increased thickness which must be accounted for in the rack system. Mica sandwich sheet systems experience greater wear at critical points which impacts the interface of the shelves with the rack, impairs integrity of the shelves, and introduces handling and cleaning issues.

Implementations of a freeze dry shelving layup may address some or all of the problems described above. The freeze dry shelving layup may include a single sheet with a surface treatment and a surface layer to provide improve thermal emissivity and greater adhesion resistance.

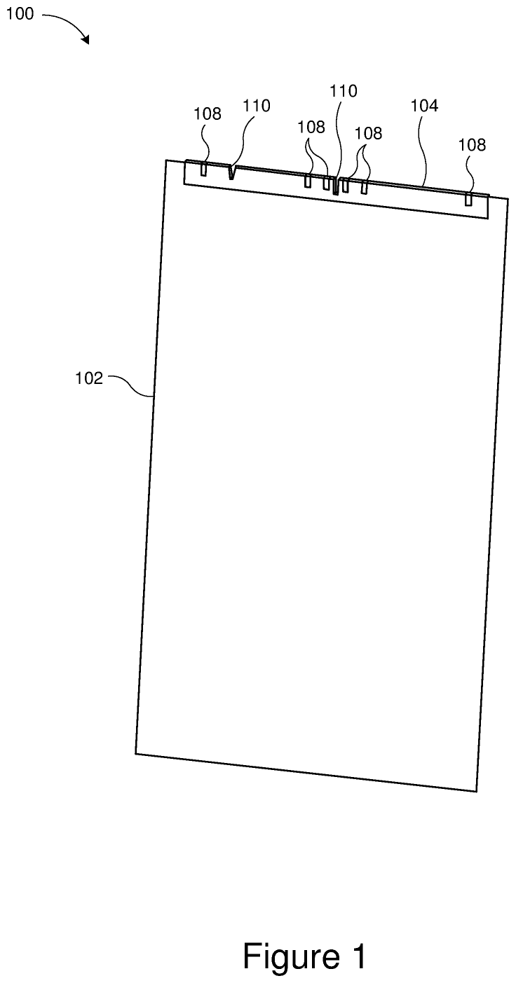

FIG. 1 illustrates a perspective view of a first side of a freeze dry shelf 100, according to an embodiment. Embodiments may provide increased thermal emissivity.

In some embodiments, the freeze dry shelf 100 includes a body 102. The body 102 may have a relatively planar geometry. For example, the body 102 may be rectangular in geometry with a thin thickness relative to a width and length of the body 102. Embodiments of the freeze dry shelf 100 may have a geometry configured to fit a rack structure or other application specific parameters. In some embodiments, the body 102 may have a monolithic form. For example, the body 102 may be a single sheet of material. Some embodiments of a single sheet may omit any internal layers or duplicate layers. In some embodiments, the body 102 may be a single layer. In other embodiments, the body 102 may be multi-layered. In some embodiments, the body 102 may be formed without folding, welding, adhering, or otherwise joining two or more layers.

In some embodiments, the body 102 is composed of a thermally conductive and/or radiative material. In one example, the body 102 includes a metal. The metal may include aluminum. Other metals may also be used. In some embodiments, the body 102 may include non-metallic components.

In some embodiments, the body 102 may be coated with or otherwise include other treatments. For example, the body 102 may be anodized. In some embodiments, the anodization may be a black anodization. Black anodization may provide an improved thermal emissivity of the body 102. The anodization may be a Type-I anodization, a Type-II anodization, a Type-III anodization. The anodization may be an acidic anodization (e.g. sulfuric, chromic, or phosphoric acid anodization), a metallic anodization (e.g. titanium anodization), or so forth. The black coloration may be organic or inorganic.

In some embodiments, the freeze dry shelf 100 includes surface contacts 108. In some embodiments, the surface contacts 108 provide electrical connection between the freeze dry shelf 100 and another component, such as a rack. The surface contacts 108 may facilitate communication of at least one of power supply, a signal for measurement or communication, or so forth. For example, one or more of the surface contacts 108 may provide power for heating of the freeze dry shelf 100. In another example, one or more of the surface contacts 108 may facilitate communication of a signal for a measurement such as temperature, humidity, pressure, air flow, or so forth.

In some embodiments, the surface contacts 108 may be positioned on the body 102 to correspond to a particular function or plurality of functions. For example, one or more of the surface contacts 108 may be positioned to correspond to a heating element, a sensor, or so forth. The surface contacts 108 may be coupled to the body 102 to correspond to a location of a surface layer 104. For example, the surface layer 104 may at least partially surround a footprint of one or more of the surface contacts 108.

The surface layer 104 may be disposed on the body 102 to provide functionality relating to wear, electrical conductivity, structural characteristics, thermal conductivity, or so forth. The surface layer 104 may also provide anti-stick properties or other characteristics impacting an interaction with another structure, object, or component. In some embodiments, the surface layer 104 is a coating. In other embodiments, the surface layer 104 is a structure applied to the body 102. For example, the surface layer 104 may be a material sprayed, deposited, or otherwise applied to the body 102 or may be a structure such as a laminate, sheet, or other structure coupled to the body 102 via adhesive or another coupling process or mechanism.

In some embodiments, the surface layer 104 includes a silicone component. In some embodiments, the surface layer 104 is reinforced silicone. The silicone may be applied as a spray, a sheet, or so forth. In some embodiments, the surface layer 104 is permanent. In other embodiments, the surface layer 104 is removable. In some embodiments, the surface layer 104 may be removable for cleaning, replacement, adaptation to application, or so forth.

The surface contacts 108 may be coupled to one or both of the body 102 or the surface layer 104 by mechanical force, chemical adhesion, deposition, printing, plating, or so forth. The surface contacts 108 may be removable or integrated. In some embodiments, the surface contacts 108 may be modular to facilitate customization, compatibility, maintenance, or so forth.

In some embodiments, the freeze dry shelf 100 also includes structural notches 110. The structural notches 110 may be formed to extend at least partially through a thickness of the surface layer 104 and/or the body 102. In other embodiments, the structural notches 110 may extend through the surface layer 104 without extending completely through the body 102. The structural notches 110 may have various geometries and/or profiles.

In some embodiments, the structural notches 110 provide physical alignment for the freeze dry shelf 100 with another structure such as a coupler, mount, rack, or so forth. For example, a structural notch 110 may be positioned or shaped to guide orientation of the freeze dry shelf 100 to reduce the chance of positioning the freeze dry shelf 100 upside down. In another example, a structural notch 110 may be positioned to guide lateral alignment. This may reduce damage to the freeze dry shelf 100, facilitate connection of the surface contacts 108, or so forth.

The structural notches 110 may also include electrical connections or other components to offer additional functionality. For example, at least one of the structural notches 110 may include an electrical connection. In another example, a sensor may be integrated with a structural notch 110.

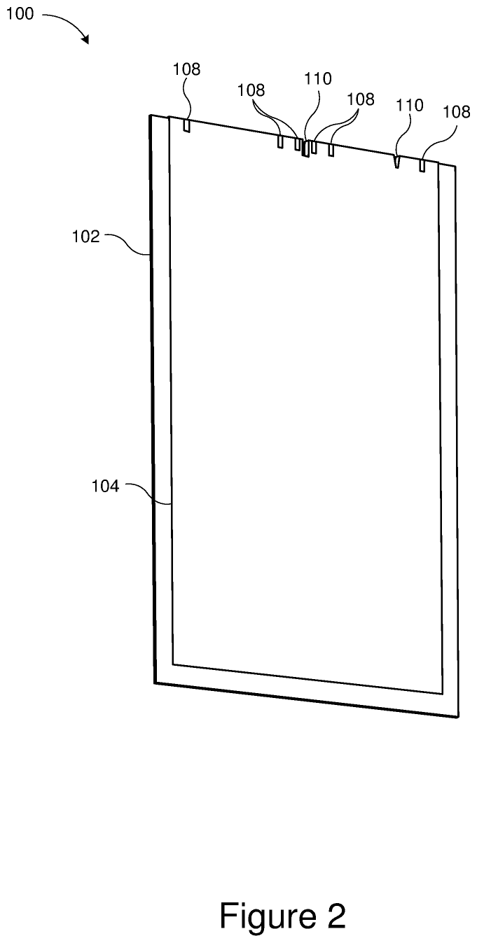

FIG. 2 illustrates a perspective view of a second side of a freeze dry shelf 100, according to an embodiment. Embodiments may allow for more effective and efficient freeze drying.

In some embodiments, the surface layer 104 of the freeze dry shelf 100 extends around an edge of the freeze dry shelf 100 and out proximate the remaining edges of the freeze dry shelf 100. The surface layer 104 may be loose at edges of the surface layer 104 or may be secured to the body 102 at the edges. In some embodiments, the body 102 may be uniform in construction. In other embodiments, the body 102 may be varied at a portion of the body 102 corresponding to the surface layer 104. In some embodiments, the surface layer 104 may be at least partially recessed in the body 102. In other embodiments, the surface layer 104 is applied to a surface of the body 102 and adds thickness to the freeze dry shelf 100. In some embodiments, the surface layer 104 overlaps with an anodization or other treatment on the body 102 of the freeze dry shelf 100. In other embodiments, the surface layer 104 may be separate from the anodization or other treatment applied to the body 102.

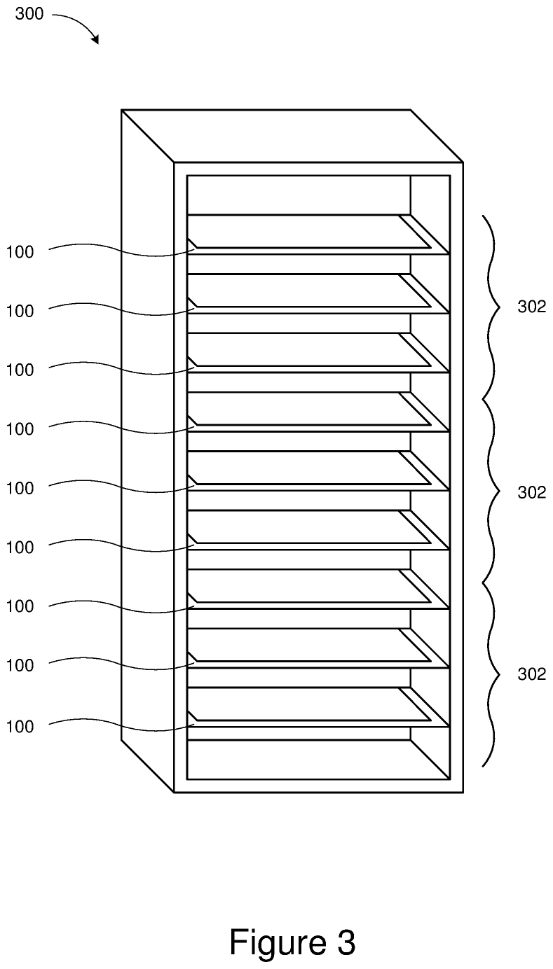

FIG. 3 illustrates a perspective view of a rack 300 of freeze dry shelves 100, according to an embodiment. Embodiments may allow higher emissivity, greater wear resistance, and improve adhesion resistance.

Embodiments of the rack 300 may include a plurality of freeze dry shelves 100. In some embodiments, the rack 300 may include a uniform set of freeze dry shelves 100 or a varied set of free dry shelves 100. In some embodiments, the shelves 100 may be distributed in an evenly spaced manner in the rack 300. In other embodiments, the shelves 100 may be spaced in a random or non-uniform pattern within the rack 300.

In some embodiments, the shelves 100 may be grouped into zones 302. Each zone 302 may have a particular spacing and/or other distinguishing characteristic. For example, a zone 302 may be configured to accommodate a specific product or to allow for a particular thermal interaction.

In some embodiments, the shelves 100 may be configured to engage with the rack 300 to secure the shelves 100 within the rack 300. For example, the shelves 100 may include a physical structure such as a notch, slot, hole, or other negative space to receive, or otherwise interface with, a securing mechanism. The shelves 100 may include a latch, catch, pin, or other securing mechanism to secure the shelves 100 relative to the rack 300.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (e.g. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. An apparatus, comprising:
a freeze dry shelf having a body comprising a planar geometry;
a treatment applied to at least a first portion of the body; and
a surface layer applied to at least a second portion of the body.

2. The apparatus of claim 1, wherein the first portion of the body and the second portion of the body overlap.

3. The apparatus of claim 1, wherein the treatment comprises an anodization applied to the body.

4. The apparatus of claim 3, wherein the anodization is a black anodization.

5. The apparatus of claim 1, wherein the surface layer comprises a wear layer.

6. The apparatus of claim 1, wherein the surface layer comprises a conductive layer.

7. The apparatus of claim 1, wherein the surface layer comprises an anti-stick layer.

8. A system, comprising:
a freeze dry shelf having a body forming a sheet;
a treatment applied to at least a first portion of the body; and
a surface layer applied to at least a second portion of the body.

9. The system of claim 8, wherein the first portion of the body and the second portion of the body overlap.

10. The system of claim 8, wherein the treatment comprises an anodization applied to the body.

11. The system of claim 10, wherein the anodization is a black anodization.

12. The system of claim 8, wherein the surface layer comprises a wear layer.

13. The system of claim 8, wherein the surface layer comprises a conductive layer.

14. The system of claim 8, wherein the surface layer comprises an anti-stick layer.

15. A method, comprising:
forming a freeze dry shelf having a body comprising a sheet;
applying a treatment to a at least a first portion of the body; and
disposing a surface layer on at least a second portion of the body.

16. The method of claim 15, wherein the first portion of the body and the second portion of the body overlap.

17. The method of claim 15, wherein applying the treatment comprises anodization.

18. The method of claim 17, wherein the anodization comprises a black anodization.

19. The method of claim 15, wherein disposing the surface layer comprises disposing a wear layer on the body.

20. The method of claim 15, wherein disposing the surface layer comprises disposing an anti-stick layer on the body.
